(19) United States
(12) Patent Application Publication
(10) Pub. No.: US 2009/0083679 A1
(43) Pub. Date: Mar. 26, 2009

(54) Efficient Second Harmonic Generation (SHG) Laser Design

(76) Inventors: Martin Achtenhagen, Plano, TX (US); John Edward Spencer, Plano, TX (US)

Correspondence Address: SLATER & MATSIL, L.L.P., 17950 PRESTON RD, SUITE 1000, DALLAS, TX, 75252-5793, US

(21) Appl. No.: 11/860,370

(22) Filed: Sep. 24, 2007

(51) Int. Cl. G06F 17/50; H01S 3/10

(52) U.S. Cl. 716/2; 372/22

(57) ABSTRACT

A method, a data processing method, and a computer program product for the design of efficient second harmonic generation semiconductor lasers is disclosed. A method for determining an optimum laser configuration includes the determination of a conversion efficiency curve for each SHG configuration using a target conversion efficiency. Each curve, on a log₁₀-log₁₀ scale, comprises a first linear portion, a knee region, and a second linear portion. Upon selecting a target SHG-power value, an SHG laser system configuration, in which the target SHG-power value is within the knee region of the conversion efficiency curve, is determined. The SHG laser system configuration is then output.

### TECHNICAL FIELD

The present invention relates generally to the design of semiconductor lasers, and more particularly to a method, a computer implemented method, and a computer program product for the design of efficient second harmonic generation semiconductor lasers.

### BACKGROUND

A laser is an optical source that emits photons in a coherent beam. Laser light is typically a single wavelength or color, and emitted in a narrow beam. Laser action is explained by the theories of quantum mechanics and thermodynamics. Many materials have been found to have the required characteristics to form the laser gain medium needed to power a laser, and these have led to the invention of many types of lasers with different characteristics suitable for different applications.

A semiconductor laser is a laser in which the active medium is a semiconductor. A common type of semiconductor laser is formed from a p-n junction, a region where p-type and n-type semiconductors meet, and powered by injected electrical current. As in other lasers, the gain region of the semiconductor laser is surrounded by an optical cavity. An optical cavity is an arrangement of mirrors or reflectors that form a standing wave resonator for light waves.

The color or frequency of the emitted light may depend on the gain medium. Another method is called frequency doubling. In this method, a fundamental laser frequency is introduced into a nonlinear medium, and a portion of the fundamental frequency is doubled. Frequency doubling in nonlinear material, also called second harmonic generation (SHG), is a nonlinear optical process, in which photons interacting with a nonlinear material are effectively combined to form new photons with twice the energy and, therefore, twice the frequency and half the wavelength of the initial photons.

Optical resonators are often called cavities, and the terms are often used interchangeably in optics. Use of the term cavity does not imply a vacuum or air space. A cavity, as used in optics, may be within a solid crystal or other medium. An optical cavity (or optical resonator) is an arrangement of optical components, which allows a beam of light to circulate. In a simple form of semiconductor laser, for example a laser diode, an optical cavity may be formed in epitaxial layers, such that the light is confined to a relatively narrow area perpendicular (and parallel) to the direction of light propagation. There are two basic types of cavities: standing-wave or linear cavities, where the light bounces back and forth between two end reflectors; and ring cavities, where the light may make round trips in two different directions.

There are at least three semiconductor SHG laser configurations: waveguide, intra-cavity, and single pass. See FIGS. 1a-1c. FIG. 1a pictures a simplified waveguide laser. SHG waveguide configuration laser 102 comprises waveguide 104, and non-linear material 106 within the waveguide. In a waveguide configuration, the second harmonic generation occurs within the waveguide. FIG. 1a depicts waveguide 104 running the length of SHG waveguide configuration laser 102 and through non-linear material 106. Arrow 103 indicates the output of SHG light.

FIG. 1b is a simplified top view of an intra-cavity laser. In an intra-cavity configuration, the light beam leaves and re-enter the laser active material by reflecting off mirrored intra-cavity surfaces 110 and 112. A first mirrored surface 110 may have a highly reflective coating. A second mirrored surface 112 may have a highly reflective coating specific to the fundamental beam wavelength and an anti-reflective coating specific to the second harmonic generation (SHG) wavelength. Pump laser 114 produces a fundamental beam. Pump laser 114 may be comprised of a laser active material, for example Yttrium aluminium garnet (Y₃Al₅O₁₂) or YAG. The fundamental beam may be, for example, an infra-red (IR) beam; however, other frequencies may be produced as a fundamental beam. The fundamental beam leaves pump laser 114 and enters non-linear material 116 where a portion of the beam is “converted” into an SHG beam, for example a green light, blue light or the like. Mirrored surface 112 allows the SHG beam to escape the intra-cavity. A portion of the fundamental beam that was not converted in non-linear material 116 is reflected back by mirrored surface 112. This portion of the fundamental beam is reflected back through non-linear material 116 and back into pump laser 114. A further portion of the fundamental beam travels through pump laser 114 and is reflected back into pump laser 114 by reflective surface 110, and re-enters pump laser 114 as feedback.

FIG. 1c illustrates the single pass configuration. In the single pass configuration, the IR light waves have a single pass at second harmonic generation. A fundamental beam 122 is focused into non-linear material 124. Boyd-Kleinman optimum focusing condition may be implemented. Both the fundamental beam 126 and the second harmonic beam 128 exit the system. Thus, the single pass configuration is aptly named because the fundamental beam has a single opportunity for generation into a second harmonic beam. Depending on the application, the remaining fundamental beam exiting the system may be filtered out of the laser system output.

Designers of applications using laser systems typically design their complex systems to function using a particular SHG power and request systems in this SHG power range. The choice of which of the three semiconductor laser configurations is implemented by the laser system design team may often be based on the configuration technology the manufacturing facility uses, however, and not the type of laser configuration that is optimally efficient for the application. Lasers systems with more capacity, thus more costly materials, may be operated at inefficiently under-powered fundamental levels to achieve a desired SHG power. In contrast, laser systems may be over-powered to achieve the desired SHG power. In other words, the laser system may be pushed beyond a reliable operating range by the practice of applying more fundamental laser power to the laser system, thereby forcing the power density of the material to a high level, and causing reliability problems such as early failure of the device.

### SUMMARY OF THE INVENTION

These problems are generally solved or circumvented, and technical advantages are generally achieved by use of a method, a data process, or a computer program product for the design of efficient SHG semiconductor laser systems.

In accordance with an illustrative embodiment of the present invention, a method for determining an efficient laser configuration includes the determination of a conversion efficiency curve for each SHG configuration. Each curve, on a log₁₀-log₁₀ scale, comprises a first linear portion, a knee region, and a second linear portion. Upon selecting a target SHG-power value, an SHG laser configuration is determined in which the target SHG-power value is within the knee region of the conversion efficiency curve. The SHG laser system configuration is then output.

An advantage of an illustrative embodiment of the present invention is in providing a laser design in which the SHG laser system configuration is efficient and reliable for the complex system's application.

The foregoing has outlined rather broadly the features and technical advantages of an illustrative embodiment in order that the detailed description of the invention that follows may be better understood. Additional features and advantages of an illustrative embodiment will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the illustrative embodiments as set forth in the appended claims.

### BRIEF DESCRIPTION OF THE DRAWINGS

For a more complete understanding of the illustrative embodiments, and the advantages thereof, reference is now made to the following descriptions taken in conjunction with the accompanying drawings, in which:

FIGS. 1a-1c are top level depictions of three SHG laser system configurations;

FIG. 2 is a pictorial representation of a distributed data processing system in which the present invention may be implemented;

FIG. 3 is a block diagram of a data processing system that may be implemented as a server in accordance with a preferred embodiment of the present invention;

FIG. 4 is a block diagram illustrating a data processing system in which the present invention may be implemented;

FIG. 5 is a top level block diagram of some components of an illustrative embodiment;

FIG. 6a is a linear graph of SHG power versus IR pump power;

FIG. 6b is a log-log graph of SHG power versus IR pump power;

FIG. 7 graphically illustrates a conversion efficiency database, such as conversion efficiency database 502 in FIG. 5;

FIG. 8 is an example of a graphical method of determining an efficient SHG configuration for a given SHG power; and

FIG. 9 is a flow chart of a method for determining a high efficiency region for an SHG laser system design.

The figures are drawn to clearly illustrate the relevant aspects of the preferred embodiments and are not necessarily drawn to scale.

### DETAILED DESCRIPTION OF ILLUSTRATIVE EMBODIMENTS

The making and using of the illustrative embodiments are discussed in detail below. It should be appreciated, however, that an illustrative embodiment provides many applicable inventive concepts that can be embodied in a wide variety of specific contexts. The specific embodiments discussed are merely illustrative of specific ways to make and use the invention, and do not limit the scope of the invention.

The present invention will be described with respect to illustrative embodiments in a specific context, namely an example of a 3.5 W target SHG power for a green light or a blue light. The invention may also be applied, however, to additional embodiments, such as other target SHG powers and other frequencies of light.

In an application entailing a complex system, design phases often occur in parallel. Each sub-system of the design has a specification that defines its critical parameters, such as size, shape, inputs that are expected and outputs that each sub-system must provide, as well as reliability expectations.

To produce an economically efficient complex system, each sub-system should be designed to operate at an economically optimum operation point. In other words, the sub-system should function at the highest possible energy efficiency, with the lowest power density possible (for reliability) and incorporate the minimum materials cost. Keeping material costs low typically means using a minimum crystal volume, thus a minimum number of devices to accomplish the desired power output. The more novel the complex system, the less likely that sub-systems provided “off the shelf” will be an optimum design for the complex system. As more applications for laser systems are developed, it may become more important that the laser systems incorporated into an application be designed to be optimum for that complex system.

Designers using laser systems in their complex systems typically specify a particular color and power that must be output by the laser system. Therefore, an SHG power range may be a likely design specification for a laser system. Different SHG laser system configurations, such as waveguide, intra-cavity, and single pass, may be capable of meeting the SHG power range specified. However, the choice of which of the three laser configurations is implemented may often be based on the technology the manufacturing facility uses, in other words the laser system offered may be an “off the shelf model” and not the laser configuration that is optimally efficient for the complex system application.

“Off the shelf” laser systems originally designed for a larger power output will necessarily contain more costly materials, and likely will be inefficiently under-powered to achieve a desired SHG power. The laser design team may design in more units to achieve the design goals, thereby increasing the cost and size of the laser system. In contrast, laser systems originally designed for a smaller output power may be over-powered and pushed beyond a reliable operating range by applying more and more fundamental laser power to the laser system to achieve the SHG power output specified. Over-powering the laser system may force the power density of the material to a high level, thereby causing reliability problems such as early device failure. A method of selecting the economically optimum SHG laser system configuration is needed. See Table 1 below for a Green 3.5 Watt case example:

TABLE 1
Green - 3.5 Watt

| | Waveguide | Intra-Cavity | Single-Pass |
|---|---|---|---|
| No. of devices | 18 devices | 24 devices | 1 device |
| Crystal Total Volume | 45 mm³ | 30 mm³ | 6.25 mm³ |
| Power Density | 5.7 MW/cm² | 1.5 MW/cm² | .56 MW/cm² |

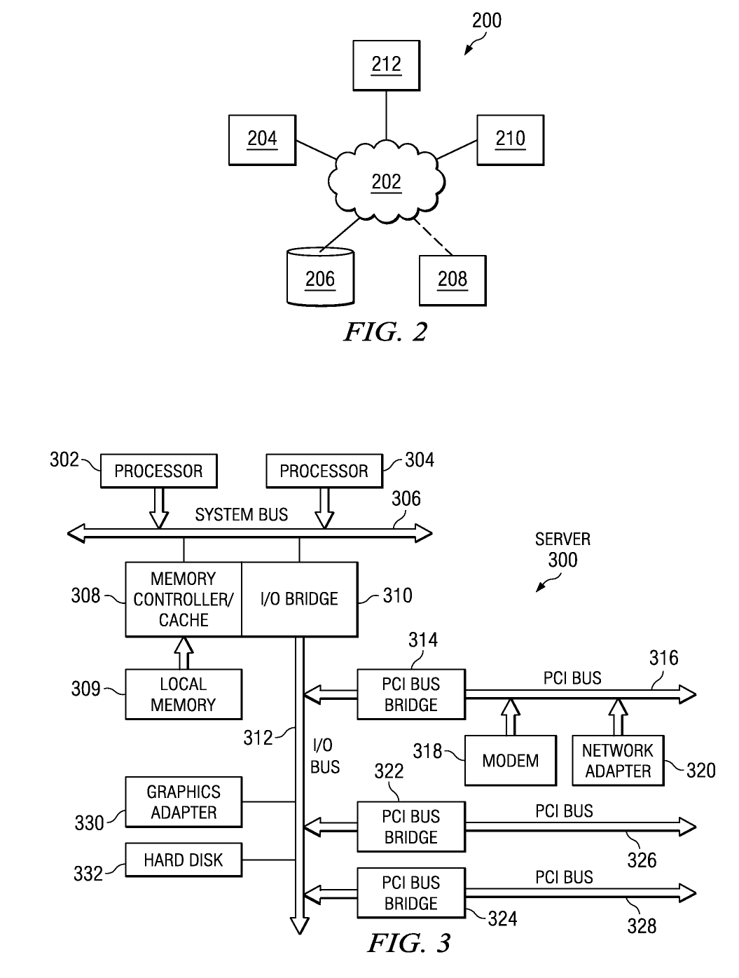

With reference now to the figures, FIG. 2 is a pictorial representation of a distributed data processing system in which an illustrated embodiment may be implemented. Distributed data processing system 200 is a network of computers. Distributed data processing system 200 contains a network 202, which is the medium used to provide communications links between various devices and computers connected together within distributed data processing system 200. Network 202 may include permanent connections, such as wire or fiber optic cables, or temporary connections made through telephone connections or wireless communications.

In the depicted example, a server 204 is connected to network 202 along with storage unit 206. In addition, clients 208, 210, and 212 also are connected to network 202. These clients 208, 210, and 212 may be, for example, personal computers or network computers. For purposes of this application, a network computer is any computer, coupled to a network, which receives a program or other application from another computer coupled to the network. In the depicted example, server 204 provides data, such as boot files, operating system images, and applications to clients 208, 210, and 212. Clients 208, 210, and 212 are clients to server 204. Distributed data processing system 200 may include additional servers, clients, and other devices not shown. In the depicted example, distributed data processing system 200 is the Internet with network 202 representing a worldwide collection of networks and gateways that use the TCP/IP suite of protocols to communicate with one another. Central to the Internet is a system of high-speed data communication lines between major nodes or host computers, consisting of thousands of commercial, educational, government and other computer systems that route data and messages. Distributed data processing system 200 also may be implemented as a number of different types of networks, such as for example, an intranet, a local area network (LAN), or a wide area network (WAN). FIG. 2 is intended as an example, and not as an architectural limitation for the illustrated embodiments.

Referring to FIG. 3, a block diagram of a data processing system that may be implemented as a server, such as server 204 in FIG. 2, is depicted. Data processing system 300 may be a symmetric multiprocessor (SMP) system including a plurality of processors 302 and 304 connected to system bus 306. Alternatively, a single processor system may be employed. Also connected to system bus 306 is memory controller/cache 308, which provides an interface to local memory 309. I/O bridge 310 is connected to system bus 306 and provides an interface to I/O bus 312. Memory controller/cache 308 and I/O bus bridge 310 may be integrated as depicted.

Bridge 314 may be, for example, a peripheral component interconnect (PCI) bus or the like and is connected to I/O bus 312, providing an interface to PCI local bus 316. A number of modems may be connected to PCI bus 316. Communications links to network computers 208-212 in FIG. 2 may be provided through modem 318 and network adapter 320 connected to PCI local bus 316.

Additional PCI bus bridges 322 and 324 provide interfaces for additional PCI buses 326 and 328, from which additional modems or network adapters may be supported. In this manner, data processing system 300 allows connections to multiple network computers. A memory-mapped graphics adapter 330 and hard disk 332 may also be connected to I/O bus 312 as depicted, either directly or indirectly.

Those of ordinary skill in the art will appreciate that the hardware depicted in FIG. 3 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 3 may be, for example, an IBM RISC/System 6000 system, a product of International Business Machines Corporation, running the Advanced Interactive Executive (AIX) operating system. The operating system may also be a commercially available operating system, such as Windows, which is available from Microsoft Corporation. An object oriented programming system such as Java may run in conjunction with the operating system and provide calls to the operating system from Java programs or applications executing on data processing system 300. Java is a trademark of Sun Microsystems, Inc. Instructions for the operating system, the object-oriented operating system, and applications or programs are located on storage devices, such as hard disk drive 332, and may be loaded into memory controller 308 for execution by processor 302.

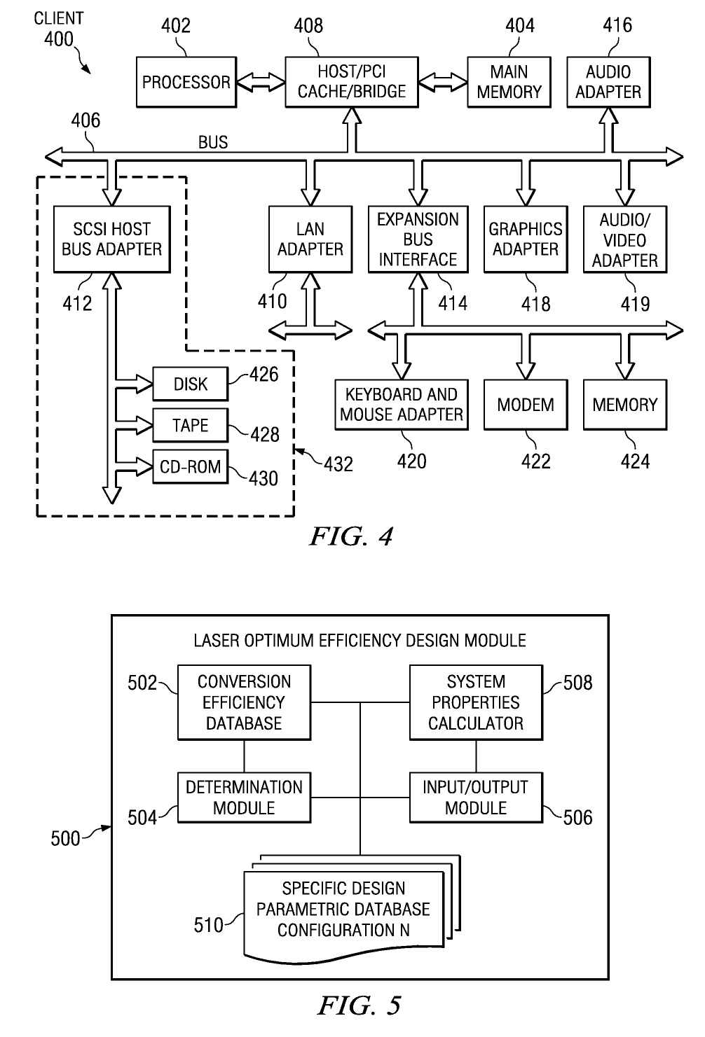

With reference now to FIG. 4, a block diagram illustrating a data processing system in which an illustrative embodiment may be implemented. Data processing system 400 may be an example of a client computer or data processing system 400 may be a stand-alone computer, or a personal digital assistant. Data processing system 400 employs a peripheral component interconnect (PCI) local bus architecture. Although the depicted example employs a PCI bus, other bus architectures such as Accelerated Graphics Port (AGP), Industry Standard Architecture (USA) and the like may be used. Processor 402 and main memory 404 are connected to PCI local bus 406 through PCI bridge 408. PCI bridge 408 also may include an integrated memory controller and cache memory for processor 402. Additional connections to PCI local bus 406 may be made through direct component interconnection or through add-in boards. For example, local area network (LAN) adapter 410, SCSI host bus adapter 412, and expansion bus interface 414 are connected to PCI local bus 406 by direct component connection. Further, audio adapter 416, graphics adapter 418, and audio/video adapter 419 are connected to PCI local bus 406. Expansion bus interface 414 provides a connection for a keyboard and mouse adapter 420, modem 422, and additional memory 424. Small computer system interface (SCSI) host bus adapter 412 provides a connection for hard disk drive 426, tape drive 428, and CD-ROM drive 430.

An operating system runs on processor 402 and is used to coordinate and provide control of various components within data processing system 400 in FIG. 4. The operating system may be a commercially available operating system, such as Windows XP, which is available from Microsoft Corporation. An object oriented programming system such as Java may run in conjunction with the operating system and provides calls to the operating system from Java programs or applications executing on data processing system 400. Java is a trademark of Sun Microsystems, Inc. Instructions for the operating system, the object-oriented operating system, and applications or programs are located on storage devices, such as hard disk drive 426, and may be loaded into main memory 404 for execution by processor 402.

Those of ordinary skill in the art will appreciate that the hardware in FIG. 4 may vary depending on the implementation. Other internal hardware or peripheral devices, such as flash ROM (or equivalent nonvolatile memory), optical disk drives and the like, may be used in addition to or in place of the hardware depicted in FIG. 4. In addition, the processes of an illustrative embodiment may be applied to a multiprocessor data processing system.

For example, data processing system 400, if optionally configured as a network computer, may not include SCSI host bus adapter 412, hard disk drive 426, tape drive 428, and CD-ROM 430, as noted by dotted line 432 in FIG. 4 denoting optional inclusion. In that case, the computer, to be properly called a client computer, must include some type of network communication interface, such as LAN adapter 410, modem 422, or the like. As another example, data processing system 400 may be a stand-alone system configured to be bootable without relying on some type of network communication interface, whether or not data processing system 400 comprises some type of network communication interface. As a further example, data processing system 400 may be a Personal Digital Assistant (PDA) device, or a notebook computer, which is configured with ROM and/or flash ROM in order to provide non-volatile memory for storing operating system files and/or user-generated data. The depicted example in FIG. 4 and above-described examples are not meant to imply architectural limitations.

FIG. 5 is a top-level block diagram of an illustrative embodiment. Laser optimum efficiency design module 500 is shown comprising conversion efficiency database 502, determination module 504, and input/output module 506, optional system properties calculator 508 and optional specific design parametrics 510 for each SHG configuration.

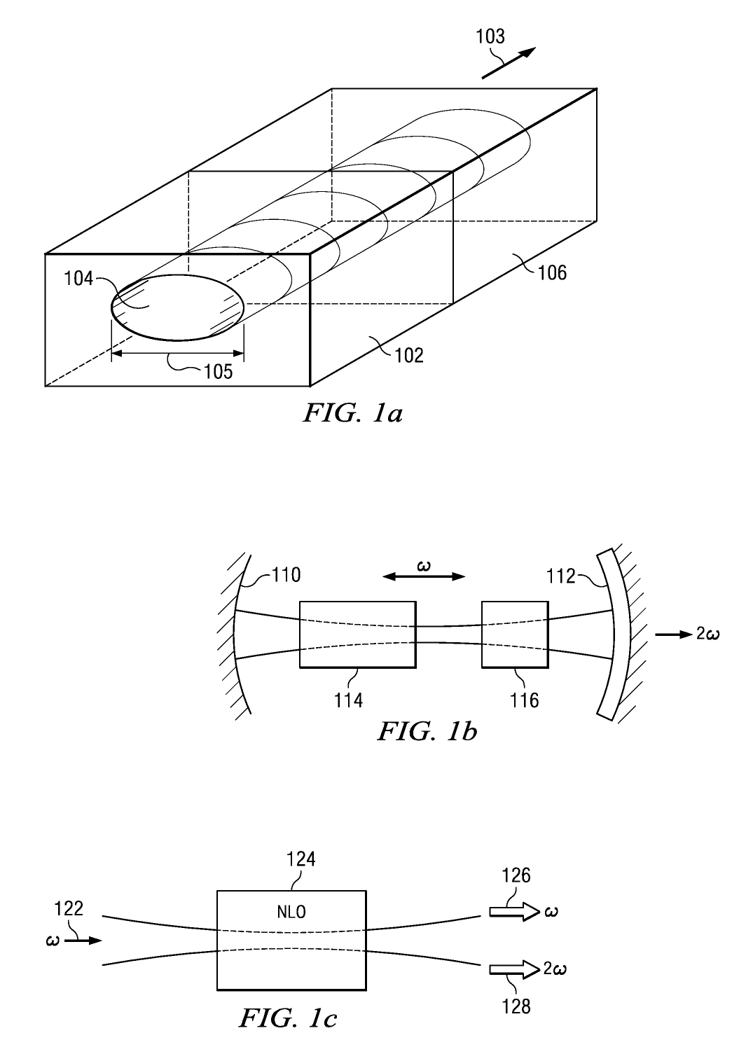

Conversion efficiency database 502 is a relational database comprising pump power data, SHG power data, configuration of laser system, and related non-linear material data. Conversion efficiency database 502 may be expanded as new data is acquired by performing direct experimentation, reviewing publications, or reverse engineering laser systems. Conversion efficiency database 502 may reside in storage 206 in FIG. 1 or hard disk 332 in FIG. 3 or the like. Conversion efficiency database 502 may be stored on a computer-readable medium, which is usable by a computer processor, either in a stand-alone system or in a network system as shown in FIGS. 2-4. Alternatively, the conversion efficiency database may be stored on paper.

Determination module 504 determines an efficient operating configuration for the SHG power desired. The processes of determination module 504 may be applied to a multiprocessor data processing system, a networked system such as depicted in FIG. 3 or a stand-alone system as depicted in FIG. 4. Determination module 504 may be implemented in a computer processor, such as processors 302 and 304 in FIG. 3 or processor 402 in FIG. 4 or the like. Determination module 504 may also be implemented manually. Input/Output module 506 may provide for communication with the laser system design team and laser system manufacturing facility. Input/output module 506 may be an input/output module such as, for example, keyboard and mouse adapter 420 and modem 422 in FIG. 4, or modem 318 and network adapter 320 in FIG. 3. Communication of an efficient configuration may also occur manually.

Optional specific design parametric database 510 may contain materials data, dimensional data, and the like, for each laser system configuration, and may be implemented similarly to conversion database 502. Through optional system properties calculator 508, the laser system design team may add additional design details of the laser system. System properties calculator 508 may use a processor such as processor 302 in FIG. 3 to implement the calculations.

The different advantageous embodiments of the present invention may take the form of an entirely hardware embodiment, an entirely software embodiment, or an embodiment containing both hardware and software elements. One advantageous embodiment is implemented in software, which includes but is not limited to forms such as firmware, resident software, and microcode.

Furthermore, the different embodiments of the present invention may take the form of a computer program product located on a computer-usable or computer-readable medium in which program code or instructions forming the computer program product are for use by a data processing system, such as a computer or other device having a processor unit capable or executing the code or instructions.

In the different embodiments, a computer-usable or computer-readable medium may be any tangible or physical apparatus that can contain, store, communicate, propagate, and/or transport the computer program product. The computer-readable medium may be an electronic, magnetic, optical, electromagnetic, or infrared semiconductor system, or a propagation medium. Examples of a computer-readable medium include a semiconductor or solid state memory, magnetic tape, removable computer diskette, random access memory (RAM), read-only memory (ROM), hard disk, and an optical disk.

In the design of SHG laser systems, the SHG conversion efficiency of the laser system is often theoretically approximated using a quadratic function such as:

P_{2ω}=ηP_{ω}²

### Where

P_{2ω}=the power of second harmonic generation beam

P_{ω}=the power of fundamental beam

η=2/π·d₃₃ and d₃₃ is the material non-linear coefficient

However, these approximations do not consider the pump depletion effects. The second-harmonic conversion efficiency including the effects of pump depletion, is as follows:

P_{2ω}=P_{ω} tan h²((ηP_{ω})^{1/2})

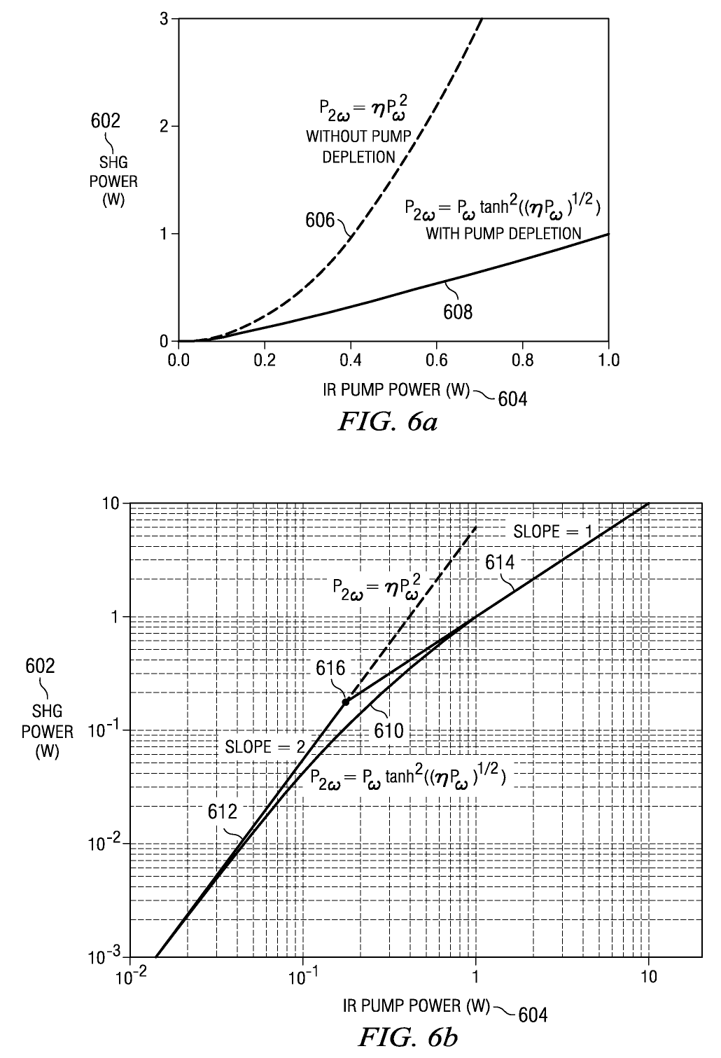

FIG. 6a is a linear graph of SHG power 602 versus IR pump power 604. The second-harmonic generation conversion efficiency 606 quadratic approximation without pump depletion is shown. The SHG conversion efficiency include pump depletion 608 is also shown. FIG. 6b shows the same relationships on a log-log scale. Note that SHG conversion efficiency curve 610 on the log-log graph may be approximated by two linear curves of different slopes and an intersection region termed a knee region herein. The first linear approximation curve 612 has a slope of 2. The second linear approximation curve 614 has a slope of 1. The intersection of the two linear approximation forms a knee region 616 of the graph.

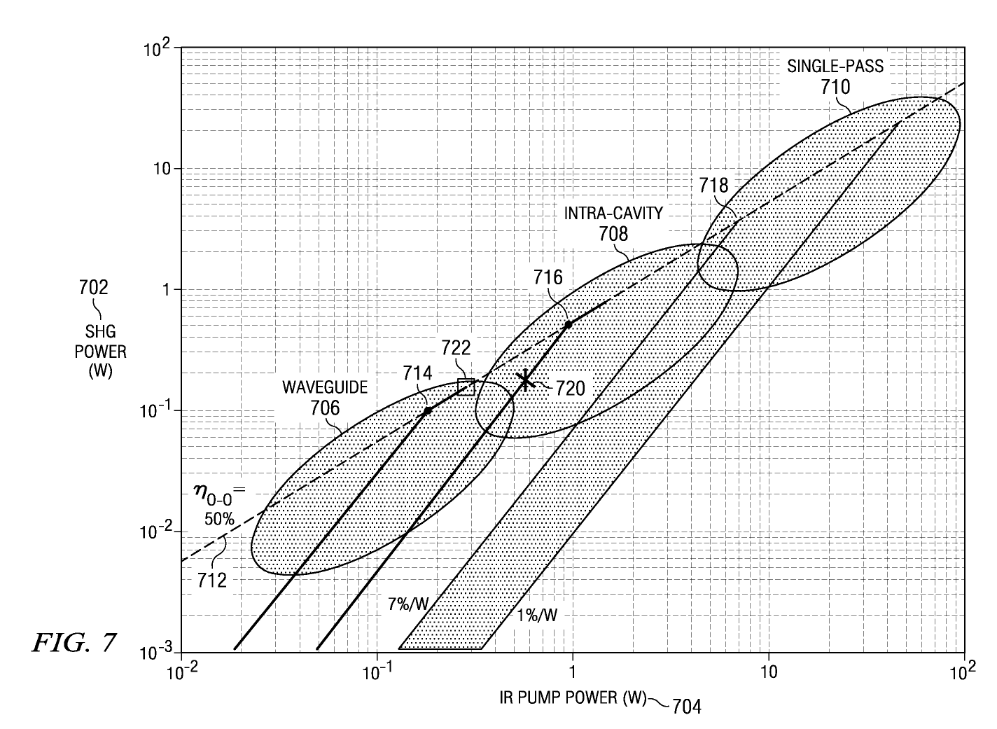

FIG. 7 graphically illustrates a conversion efficiency database such as conversion efficiency database 502 in FIG. 5. On a log-log scale, SHG power 702 versus IR pump power 704 is plotted for each laser system configuration, waveguide 706, intra-cavity 708, and single-pass 710. In theory, these curves are a continuum as the geometries of one configuration blend into the geometries of an adjacent configuration. However, in practice, those of ordinary skill in the art are well versed in the separate configurations. An approximation curve (region) for each configuration type is shown with a first linear slope area, a knee region, and a second linear slope area as shown in the pump depletion approximation in FIG. 6b. Laser efficiency curve 712 is shown with a laser efficiency (ηₒ₋ₒ) of 50%. Waveguide knee region 714, intra-cavity waveguide 716 and single pass knee region 718 are shown for specific efficiencies. Experimental data may show that the knee region for a specific example may fall above or below this specified laser efficiency curve. Lasers functioning in the first linear region (below the knee regions 714, 716 and 718) such as laser at point 720 are not functioning at full capacity and therefore are unlikely to be efficient. If the IR pump is under-powered, the IR pump drives a lower SHG power; the result is an inefficient use of expensive non-linear materials. Lasers functioning in the second linear region, such as laser at point 722 are above a reliable power density and so may fail early. If the IR pump power is increased from knee region 714, the power density in the crystal may become too high and cause reliability problems in the laser system. Conversion efficiency database 502 may contain many such laser points, and the design team may input more data laser points into the database based on experimental data for existing waveguide, intra-cavity and single-pass SHG configurations as they become available. The conversion efficiency database may also be expanded for new SHG configurations as needed.

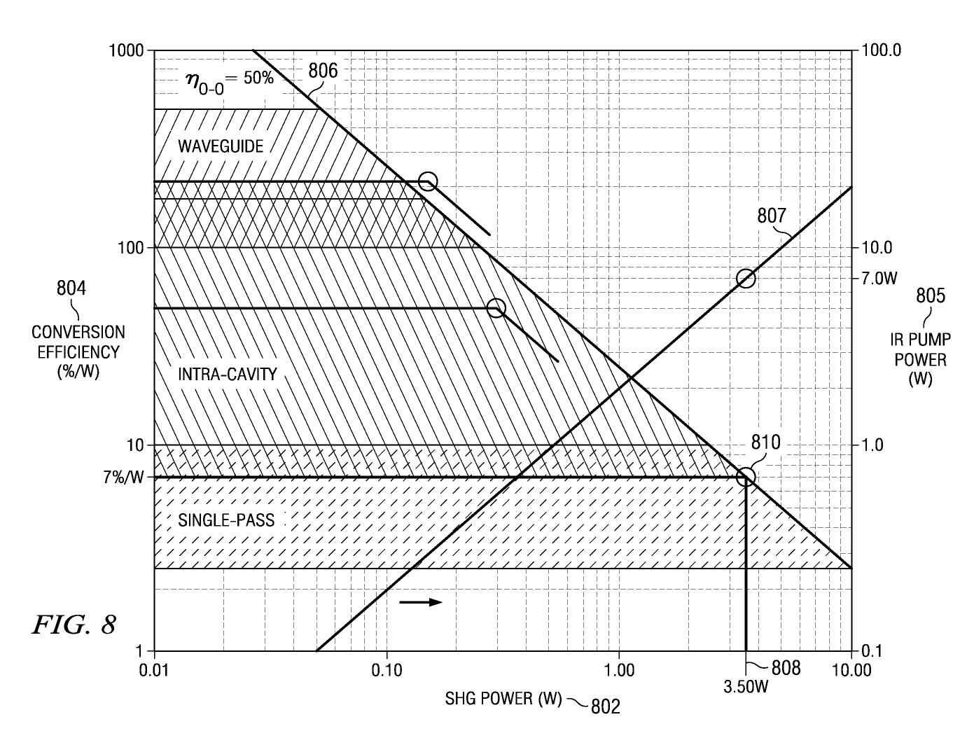

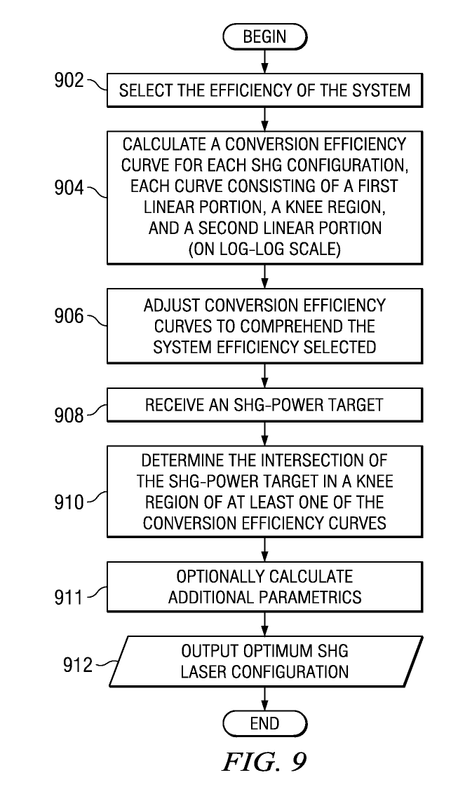

FIG. 8 is an example of a graphical method of determining an efficient SHG configuration for a given SHG power. To those of ordinary skill in the art the graphical method of determining an efficient configuration can be readily converted to computer implemented processes as shown in FIG. 9. Conversion efficiency 804 versus SHG power 802 is plotted on a log-log scale. Right axis 805 is IR pump power—this axis relates to curve 807. The system efficiency (ηₒ₋ₒ) 806 is the selected efficiency of the system, in this example set at 50% efficiency. Efficiency numbers may be selected based on the application, for example, a projector may require 65% system efficiency while a laser pointer may only require 40% system efficiency. The target SHG power 808 is plotted on the graph. The intercept between the target SHG power 808 and a knee region of a laser configuration is then found at optimum point 810. In this example case, the efficient SHG configuration of the laser system is thus determined to be a single pass system with a 7%/W conversion efficiency. The IR pump power is 7 W. In another embodiment, the data, determination and output of the results are implemented in a computer system, such as the network of FIG. 2 and/or the stand alone computer of FIG. 4.

FIG. 9 is a flow chart of a method for determining an efficient region for an SHG laser system design. The process begins with the selection or the input of the selection of the efficiency of the system (step 902). Next, the process determines conversion efficiency relationships for each SHG configuration (step 904). Each SHG configuration relationship has a first linear region, a knee region, and a second linear region. The process then adjusts the conversion efficiency curves (or limits the relationship in a computer implemented embodiment) to comprehend the system efficiency selected (step 906). The process receives an SHG-power target (step 908). The process then determines the intersection of the SHG-power target in a knee region of at least one of the conversion efficiency curves (step 910). Optionally the process may calculate other parametrics of the efficient laser system, such as dimensions, type of non-linear material, and the like (step 911). The data used for step 911 may reside in a specific design parametric database, such as specific design database 510 shown in FIG. 5. The calculations for the specific parametrics may be made in a system process calculator, such as system process calculator 508 in FIG. 5. The process then outputs the SHG laser configuration (such as single-pass as in the example in FIG. 8), the %/W conversion efficiency needed, and the pump power needed for optimum operation (step 912). Optionally the process may output additional parametrics (step 912).

Although the illustrative embodiment and its advantages have been described in detail, it should be understood that various changes, substitutions, and alterations can be made herein without departing from the spirit and scope of the invention as defined by the appended claims. For example, many of the features and functions discussed above can be implemented in software, hardware, or firmware, or a combination thereof. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for determining a configuration for a laser comprising:
determining a conversion efficiency curve for each SHG configuration of a plurality of SHG configurations for a laser, the curve being determined using a target conversion efficiency, wherein each curve on a log₁₀-log₁₀ scale comprises a first linear portion, a knee region, and a second linear portion;
receiving a target SHG-power value;
determining at least one SHG configuration, wherein the target SHG-power value is within the knee region of the conversion efficiency curve; and
outputting the at least one SHG configuration for the target SHG power.

2. The method of claim 1, further comprising manufacturing the laser based on an output SHG configuration.

3. The method of claim 1, wherein the laser has an infra-red fundamental beam.

4. The method of claim 3, wherein the laser has an output of a substantially green beam.

5. The method of claim 3, wherein the laser has an output of a substantially blue beam.

6. The method of claim 1, wherein the at least one SHG configuration includes at least one SHG configuration physical dimension.

7. The method of claim 1, wherein the at least one SHG configuration includes a type of non-linear material.

8. The method of claim 1, wherein the method is computer implemented.

9. A data process for determining an optimum SHG laser configuration, the process comprising:
a means for determining a conversion efficiency curve for each SHG configuration using a target conversion efficiency, wherein each curve on a log₁₀-log₁₀ scale comprises a first linear portion, a knee region, and a second linear portion;
a means for receiving a target SHG-power value;
a means for determining an at least one SHG configuration, wherein the target SHG-power value is within the knee region of the conversion efficiency curve; and
a means for outputting the at least one SHG configuration for the target SHG power.

10. The data process of claim 9 further comprising a means for determining additional parametrics.

11. A computer program product comprising a computer usable medium including computer usable program code for determining an efficient SHG laser design, the computer program product including:
computer usable program code for determining a conversion efficiency curve for each SHG configuration using a target conversion efficiency, wherein each curve on a log₁₀-log₁₀ scale comprises a first linear portion, a knee region, and a second linear portion;
computer usable program code for receiving a target SHG-power value;
computer usable program code for determining an at least one SHG configuration, wherein the target SHG-power value is within the knee region of the conversion efficiency curve; and
computer usable program code for outputting the at least one SHG configuration for the target SHG power.

12. The computer program product of claim 11 further comprising:
computer usable program code for including in the output of the at least one SHG configuration a type of non-linear material.

13. The computer program product of claim 11 further comprising:
computer usable program code for including in the output of the at least one SHG configuration a physical dimension.

14. The computer program product of claim 11, wherein the computer usable program code resides on a web-based server.

15. The computer program product of claim 11, wherein the computer usable program code resides on a portable medium.
